(19) United States
(12) Patent Application Publication
(10) Pub. No.: US 2013/0326328 A1
(43) Pub. Date: Dec. 5, 2013

(54) Method and System For Measuring Opportunity To See By A Panelist Using A Router-Based Web Meter

(71) Applicants: Nick Salvatore Arini, Botley (GB); Simon Michael Rowe, Finchampstead (GB); Jonny Protheroe, London (GB); Roman Kirillov, London (GB)

(72) Inventors: Nick Salvatore Arini, Botley (GB); Simon Michael Rowe, Finchampstead (GB); Jonny Protheroe, London (GB); Roman Kirillov, London (GB)

(21) Appl. No.: 13/485,790

(22) Filed: May 31, 2012

(51) Int. Cl. G06F 17/00; G06F 15/16

(52) U.S. Cl. 715/234

(57) ABSTRACT

A method for determining a user's web browsing activities on a computing device is implemented at a computer system having memory and one or more processors. The computer system is communicatively coupled to the computing device. The computer system receives one or more documents from one or more web servers, the one or more documents being responsive to a user request from the computing device and comprising information for rendering a web page on a display of the computing device. The computer system modifies at least one of the one or more documents by inserting a program into the document and sends the one or more documents including the modified document to the computing device. When the program is executed by the computing device in connection with rendering a web page, the program is configured to determine which part of the web page is displayed on the computing device.

### TECHNICAL FIELD

The disclosed implementations relate generally to a web content metering system, and in particular, to system and method for measuring opportunity to see (OTS) by a panelist using a router-based web meter.

### BACKGROUND

Traditionally, the number of impressions of a particular piece of content is used as the measure of the number of times that the piece of content was displayed to end users/viewers. For example, each time that an ad is displayed to a user is counted as one impression for the ad. But an impression of the ad by the user (which is probably associated with a request to a corresponding ad server) does not necessarily mean that the user has actually been exposed to the ad. For example, the ad may be positioned at the bottom of a web page such that it is outside the browser window. If so, the user may not be exposed to the ad unless he or she scrolls the web page down to bring the ad into the browser window. Sometimes, in response to a user request, a web browser downloads and displays multiple web pages side by side, each web page having a respective tab. But unless a user selects a tab, that user will never be able to view an ad in the corresponding web page. Both of these examples illustrate situations where actual user exposure to content (including ads) is not accurately measured by content impressions.

### SUMMARY

In accordance with some implementations described below, a method for determining a user's web browsing activities on a computing device is disclosed. The method includes: receiving, at a network device, one or more documents from one or more web servers, wherein the one or more documents are responsive to a user request from the computing device and comprise information for rendering a web page on a display of the computing device; modifying at least one of the one or more documents by inserting a program into the document, wherein, when the program is executed by the computing device in connection with rendering a web page, the program is configured to determine which part of the web page is displayed on the computing device; and sending the one or more documents including the modified document to the computing device.

In accordance with some implementations described below, a method for determining a user's web browsing activities on a computing device is disclosed. The method includes: receiving, at a network device, one or more documents from one or more web servers, wherein the one or more documents are responsive to a user request from the computing device and comprise information for rendering a web page on a display of the computing device; modifying at least one of the one or more documents by inserting a program into the document, wherein, when the program is executed by the computing device in connection with rendering a web page, the program is configured to determine which part of the web page is displayed on the computing device; and sending the one or more documents including the modified document to the computing device.

In accordance with some implementations described below, a computer system for determining a user's web browsing activities on a computing device is disclosed, the computer system having memory to store one or more programs and one or more processors for executing the one or more programs. The one or more programs, when executed by the one or more processors, cause the computer system to: receive one or more documents from one or more web servers, wherein the one or more documents are responsive to a user request from the computing device and comprise information for rendering a web page on a display of the computing device; modify at least one of the one or more documents by inserting a program into the document, wherein, when the program is executed by the computing device in connection with rendering a web page, the program is configured to determine which part of the web page is displayed on the computing device; and send the one or more documents including the modified document to the computing device.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating a distributed network environment including network routers, a proxy server, and an OTS server for measuring web contents displayed to users at different clients in accordance with some implementations.

FIG. 2A is a block diagram illustrating how a network router inspects and modifies web content before providing it to a client and how the modified content causes the client to report user activities to an OTS server in accordance with some implementations.

FIG. 2B is a block diagram illustrating how a network router and a proxy server work in concert to inspect and modify web content before providing it to a client and how the modified content causes the client to report user activities to an OTS server in accordance with some implementations.

FIG. 3 is a block diagram illustrating the components of a proxy server that are configured for inspecting and modifying web contents in accordance with some implementations.

FIG. 4 is a block diagram illustrating the components of an OTS server that are configured for managing user activity data associated with the modified web contents in accordance with some implementations.

FIG. 5A is a flow chart illustrating how a network router inspects/modifies web contents for measuring user activities associated with the web contents before providing the modified web contents to a client in accordance with some implementations.

FIG. 5B is a flow chart illustrating how a network router works in concert with a proxy server for inspecting/modifying web contents for measuring user activities associated with the web contents before providing the modified web contents to a client in accordance with some implementations.

### DETAILED DESCRIPTION

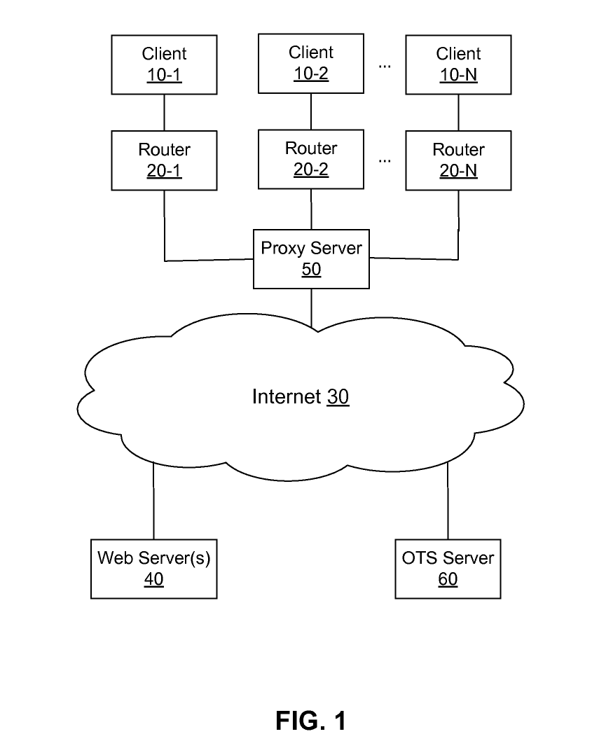

FIG. 1 is a block diagram illustrating a distributed network environment including network routers, a proxy server, and an opportunity to see (OTS) server for measuring web contents displayed to users at different clients in accordance with some implementations. In this case, a client (10-1, 10-2, 10-N) is a computing device used by an end user for accessing the Internet 30, such as a desktop, laptop, a tablet computer, a netbook computer, a mobile phone, etc. Each client is communicatively coupled to a respective network router (20-1, 20-2, 20-N) through a wired connection (e.g., Ethernet) or a wireless connection (e.g., Wi-Fi).

A network router is located at a household and exchanges data packets with one or multiple clients in the household. In some implementations, the network router is configured to inspect the data packets sent to or received from the clients for various purposes, e.g., determining the association between a data packet and a respective client, preventing network attacks, etc. Multiple network routers are connected to a proxy server 50. The proxy server 50 is a device located between multiple clients and the rest of the Internet 30 (e.g., web servers 40) and its functions include pre-fetching web contents from the web servers 40 and storing them in a local database so that the proxy server 50 can serve a client request for certain web contents more promptly if the requested web contents are already in the local database.

There are multiple ways of measuring the opportunity to see (OTS) specific web content for an end user, some of which measure a user's activities on the web content regardless of whether or not the user has agreed to such measurement. But as described below, the approaches discussed in the present application are based on the assumption that end users are given the opportunity to opt into (or out of) use of the OTS metering programs. For example, the end users are participants of web metering panels who have agreed, expressly or implicitly, that when and where the OTS metering programs can be employed to determine the opportunity to see for web pages received at the router in order to more accurately measure web usage of the participants.

In some implementations, OTS metering software is downloaded onto a client after a user at the client authorizes such downloading. The downloaded OTS metering software is configured to measure the user's web browsing activities, including the user's activities on specific web content (e.g., ads), and send user activities reports to the OTS server 60. Note that this approach limits the OTS measurement to a particular computing device that has installed the OTS metering software. If a household has multiple computing devices with Internet access capability (which is very common today), this approach will not be able to capture the user activities on a computing device that does not install the software.

In some implementations (as will be described in more detail below), an entity such as the network routers (20-1, 20-2, 20-N) or the proxy server 50 is configured to inspect the web content to be sent to a particular client and determine whether the web content satisfies one or more predefined conditions. If the web content satisfies the predefined conditions, the network router 20 or the proxy server 50 or both will work in concert to modify or update the web content by introducing OTS metering software into the web content to be measured and then send the modified web content to a client that requests such content. This approach typically involves a third-party that has access to or control over the network routers (20-1, 20-2, 20-N) or the proxy server 50. For example, a company, which is interested in metering the users' web browsing activities in a household, may provide a customized network router to the household and also enter a contract with the household members such that they agree that their web browsing activities be logged and analyzed for various purposes.

Besides performing router-related functions, the customized network router is configured to intercept one or more data packets from a web server and investigate whether the data packets satisfy one or more predefined conditions. For example, one predefined condition is that data packets returned from a predefined web server (e.g., an ad server) should be modified to include the OTS metering software for measuring the user's exposure to certain ad. In this case, the customized network router will at least look into the header of a data packet to determine whether it is from a particular web server and, if so, take actions accordingly, e.g., generating one or more data packets including an OTS metering program and forwarding the data packets to a client that is supposed to receive the ad-related data packets.

In some implementations, the task of inserting an OTS metering program into a stream of data packets is split into two sub-tasks. For example, the network router is responsible for data packet inspection. Whenever identifying a set of data packets that require OTS metering service, the network router notifies the proxy server by sending one or more identified data packets to the proxy server, which is responsible for data packet modification. This split of task is more preferred if the network router has limited data processing capability and it may take a substantial amount of time to have the network router modify the data packets, which would adversely affect the user experience at the client that receives the data packets.

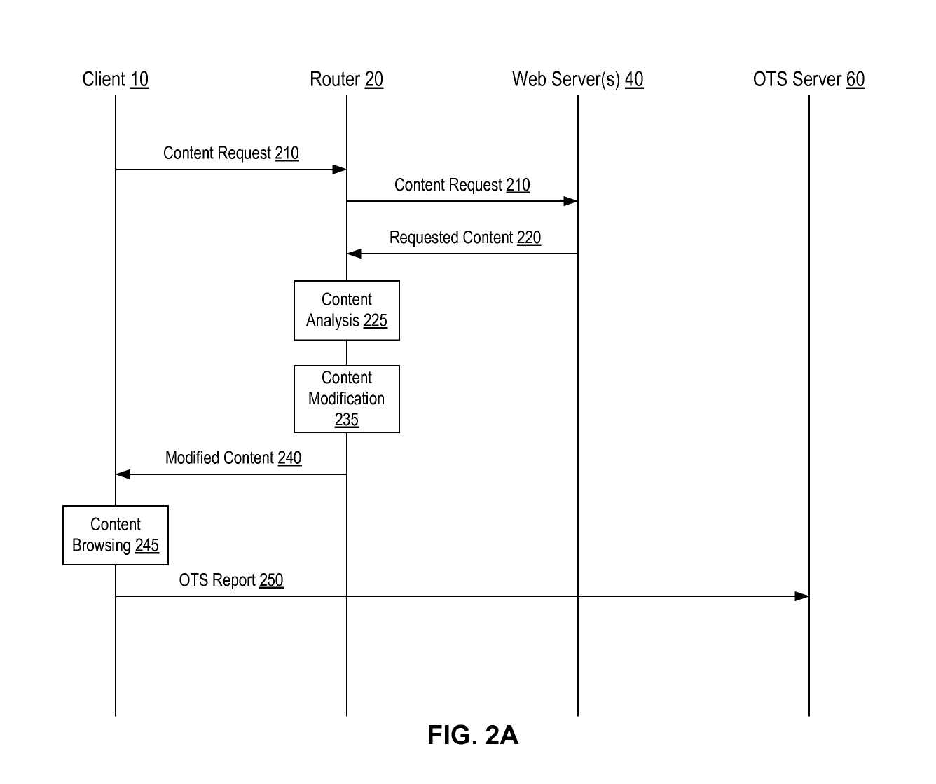

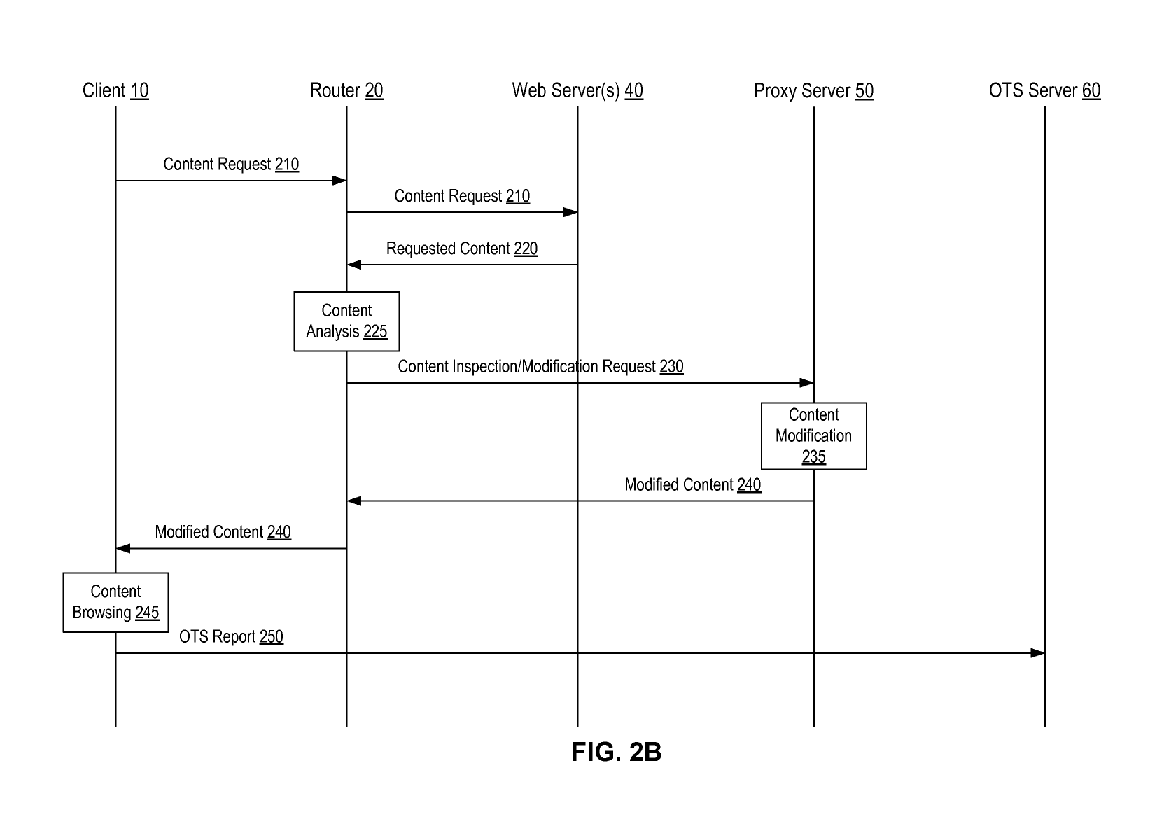

FIG. 2A is a block diagram illustrating how a network router inspects and modifies web content before providing it to a client and how the modified content causes the client to report user activities to an OTS server in accordance with some implementations. Initially, the client 10 sends a web content request 210 to a network router 20. For example, this content request may be generated by a user selection of a web page or a mouse click of a link in a web page. The network router 20 then forwards the request 210 to one or more web servers 40. Note that a web content request, although initially directed to a particular web server, often invokes other web servers because the web content requested by the client may be hosted by multiple web servers.

In response to the request, the web servers 40 prepare the requested web content 220 and return the content 220 to the requesting client 10 via the router 20. As shown in FIG. 2A, upon receipt of the requested content 220 (e.g., in the form of a set of data packets representing a web page), the network router 20 will perform two operations relating to web browsing measurement. For example, the network router 20 conducts content analysis 225 of the requested content through, e.g., data packet inspection including opening one or more data packets, identifying the headers of the data packets, and comparing the content of the packet headers with one or more predefined conditions. In some implementations, the network router may also examine other portions of the data packets, e.g., checking whether there is a predefined indicator in the data carried by the packets. If the predefined conditions are met, or a predefined indicator is found, or both, the router 20 then performs the content modification 235 to the requested content 220. In some implementations, the content modification 235 includes generating one or more data packets for carrying an OTS metering program and inserting the newly-generated data packets into the data packets that come from the web servers 40. After the two operations, the network router 20 turns the requested content 220 into the modified content 240. In some implementations, the modified content 240 includes both the newly-generated data packets and the other data packets and arrives at the client 10 as one coherent response to the original content request 210.

Next, the client 10 invokes the OTS metering program to measure a user's content browsing 245 and generate an OTS report 250 accordingly. In some implementations, the OTS report includes whether the user has accessed a predefined portion of a web page (e.g., an ad), when the user starts/stops browsing the predefined portion, whether the user has any further interaction with the predefined portion (e.g., moving a mouse cursor into the predefined portion or clicking a link in the predefined portion), etc. Note that it would be apparent to one skilled in the art that the OTS metering program may measure other attributes associated with the user's web browsing activities. Finally, the client 10 (or more specifically, the OTS metering program running on the client 10) sends the OTS report 250 to the OTS server 60 according to a predefined schedule.

Note that it is assumed that the network router 20 shown in FIG. 2A has sufficient data processing/storage capability to handle both content analysis 225 and content modification 235. In some cases, if the network router does not have enough processing power, it may share the responsibility with another entity, e.g., a proxy server on the data path between the client 10 and the web servers 40, and allocate part of the responsibility that requires more data processing capability to the proxy server.

FIG. 2B is a block diagram illustrating how a network router and a proxy server work in concert to inspect and modify web content before providing it to a client and how the modified content causes the client to report user activities to an OTS server in accordance with some implementations. Note that the initial stage of the process, including the content request 210 from the client 10 to the router 20 and then to the web servers 40, the requested content 220 from the web servers 40 to the router 20, and the content analysis 225 at the router 20, is similar to the corresponding steps described above in connection with FIG. 2A.

As part of or following the content analysis 225, if the router 20 determines that the web content, which is to be provided to the client 10, satisfies certain predefined conditions that might require measuring user activities on the web content, the router 20 will send a content inspection/modification request 230 to a proxy server 50. In response, the proxy server 50 performs content modification 235 to the web content identified by the router 20 by inserting, e.g., an OTS metering program into a set of data packets corresponding to the web content.

In some implementations (as shown in FIG. 1), the proxy server 50 is positioned along the data path from the web server 20 to the client 10 such that it will receive any data packet before the router 20. Thus, the proxy server 50 may be configured to keep a copy of each data packet that passes through the proxy server 50 for a predefined amount of time. The router 20 may only check a subset of the web content, e.g., the headers of the data packets that carry the web content, to determine if they are originated from a predefined source such as an ad server. If so, the router 20 only needs to identify those data packet identifiers (e.g., in the form of a range of data packet identifiers if they are monotonically continuous) in the request 230. The proxy server 50 then identifies those data packets based on the router-provided data packet identifiers and performs the content modification 235 to the data packets by adding an OTS metering program into the web content. The proxy server 50 sends the modified content 240 to the router 20 and the router 20 then forwards the modified content 240 to the client 10 for display to an end user at the client 10.

The client 10 then invokes the OTS metering program to measure a user's content browsing 245 and generate an OTS report 250 accordingly. At the end, the client 10 (or more specifically, the OTS metering program running on the client 10) sends the OTS report 250 to the OTS server 60 according to a predefined schedule.

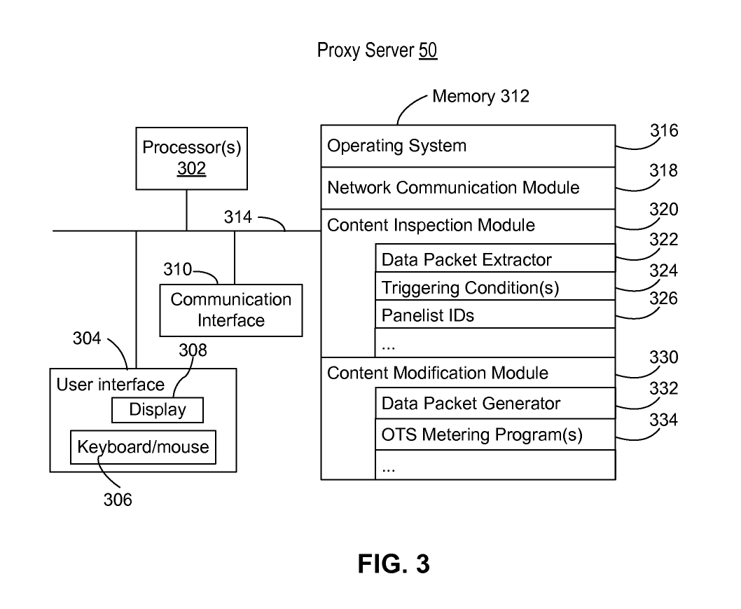

FIG. 3 is a block diagram illustrating the components of a proxy server 50 that are configured for inspecting and modifying web contents in accordance with some implementations. The proxy server 50 includes one or more processors 302 for executing modules, programs and/or instructions stored in memory 312 and thereby performing predefined operations; one or more network or other communications interfaces 310; memory 312; and one or more communication buses 314 for interconnecting these components. In some implementations, the proxy server 50 includes a user interface 304 comprising a display device 308 and one or more input devices 306 (e.g., keyboard or mouse).

Memory 312, or alternately one or more storage devices within memory 312, includes a non-transitory computer readable storage medium. In some implementations, the memory 312 and/or the non-transitory computer readable storage medium includes high-speed random access memory, such as DRAM, SRAM, DDR RAM or other random access solid state memory devices. In some implementations, memory 312 and/or the non-transitory computer readable storage medium includes non-volatile memory, such as one or more magnetic disk storage devices, optical disk storage devices, flash memory devices, or other non-volatile solid state storage devices. In some implementations, memory 312 and/or the non-transitory computer readable storage medium includes one or more storage devices remotely located from the processor(s) 202. In some implementations, memory 312 or the computer readable storage medium of memory 312 stores the following programs, modules and data structures, or a subset thereof:
an operating system 316 that includes procedures for handling various basic system services and for performing hardware dependent tasks;
a network communications module 318 that is used for connecting the proxy server 50 to other computers (e.g., the router 20) via the communication network interfaces 310 and one or more communication networks (wired or wireless), such as the Internet, other wide area networks, local area networks, metropolitan area networks, etc.;
a content inspection module 320 for inspecting web contents that travel through the proxy server 50, the content inspection module 320 further including a data packet extractor 322 for opening a data packet and inspecting different portions of the data packet against one or more OTS measurement triggering conditions 324 and one or more panelist IDs 326 that identify end users that have agreed to have their web browsing activities measured; and
a content modification module 330 for modifying web contents to embed a program for measuring user activities on the web contents, the content modification module 330 further including a data packet generator 332 for generating one or more data packets carrying an OTS metering program 334 and, if necessary, updating other data packets such that the newly-generated data packets are seamlessly combined with the other data packets representing the web content returned from a web server 40.

It should be noted that at least some or all of the functionalities of the proxy server 50 may be implemented in a network router 20 as described above in connection with FIGS. 2A and 2B, respectively.

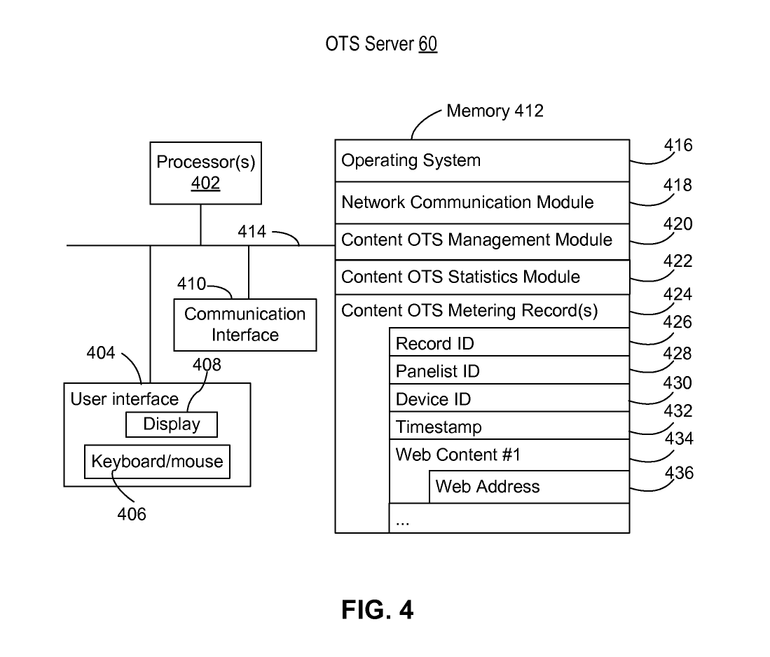

FIG. 4 is a block diagram illustrating the components of an OTS server 60 that are configured for managing user activity data associated with the modified web contents in accordance with some implementations. The OTS server 60 includes one or more processors 402 for executing modules, programs and/or instructions stored in memory 412 and thereby performing predefined operations; one or more network or other communications interfaces 410; memory 412; and one or more communication buses 414 for interconnecting these components. In some implementations, the OTS server 60 includes a user interface 404 comprising a display device 408 and one or more input devices 406 (e.g., keyboard or mouse).

Memory 412, or alternately one or more storage devices within memory 412, includes a non-transitory computer readable storage medium. In some implementations, the memory 412 and/or the non-transitory computer readable storage medium includes high-speed random access memory, such as DRAM, SRAM, DDR RAM or other random access solid state memory devices. In some implementations, memory 412 and/or the non-transitory computer readable storage medium includes non-volatile memory, such as one or more magnetic disk storage devices, optical disk storage devices, flash memory devices, or other non-volatile solid state storage devices. In some implementations, memory 412 and/or the non-transitory computer readable storage medium includes one or more storage devices remotely located from the processor(s) 402. In some implementations, memory 412 or the computer readable storage medium of memory 412 stores the following programs, modules and data structures, or a subset thereof:
an operating system 416 that includes procedures for handling various basic system services and for performing hardware dependent tasks;
a network communications module 418 that is used for connecting the OTS server 60 to other computers (e.g., the client 10, the router 20, and the proxy server 50) via the communication network interfaces 410 and one or more communication networks (wired or wireless), such as the Internet, other wide area networks, local area networks, metropolitan area networks, etc.;
a content OTS management module 420 for managing data relating to user web browsing activities from a plurality of clients 10 and processing requests for accessing such data from an end user (e.g., a data analyst);
a content OTS statistics module 422 for perform statistical analysis of the data relating to user web browsing activities from a plurality of clients 10; and
a plurality of content OTS metering records 424, each content OTS metering record including a record ID 426, a panelist ID 428 of a particular household member who generates the user browsing activities associated with the record (if possible), a device ID 430 of a particular computing device in the household from which the household panelist browses the web content (if possible), a timestamp 432 indicating when the web browsing activities occur, and one or more pieces of web content 434, each piece of web content including a web address 436 (e.g., a URL) of the web content on the Internet.

Finally, two flow charts are described below, which correspond to the two implementations described above in connection with FIGS. 2A and 2B, respectively.

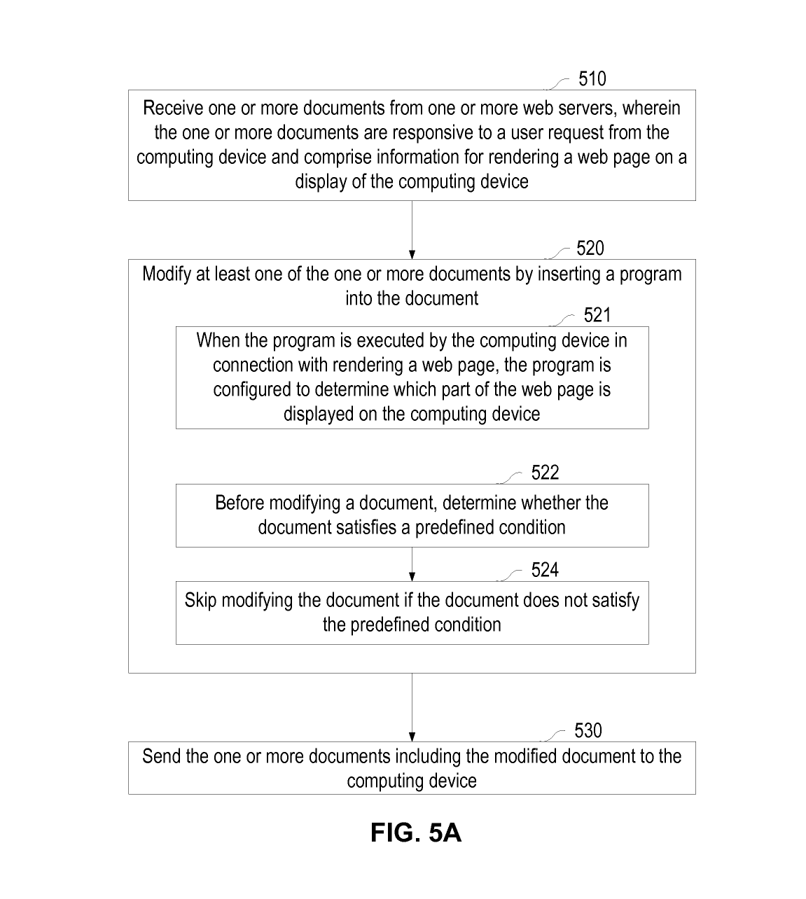

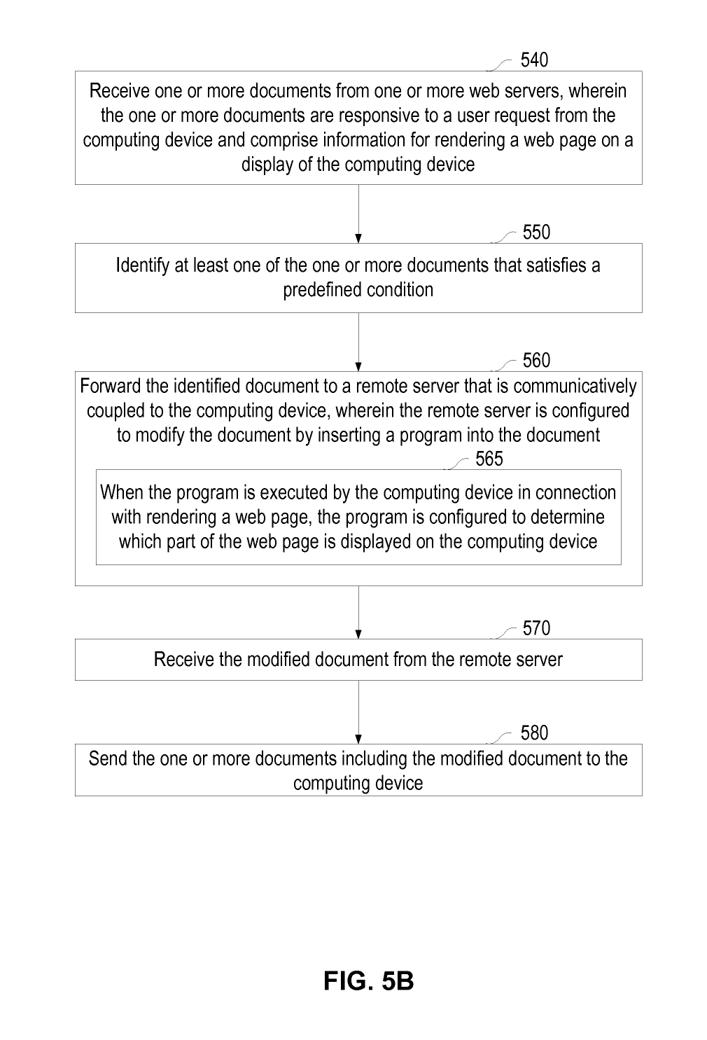

FIG. 5A is a flow chart illustrating how a network router (e.g., the network router 20) inspects/modifies web contents for measuring user activities associated with the web contents before providing the modified web contents to a client computing device in accordance with some implementations. The network router receives (510) one or more documents from one or more web servers. In some implementations, the one or more documents are responsive to a user request from the client computing device and comprise information for rendering a web page or a portion thereof on a display of a computing device.

Next, the network router modifies (520) at least one of the one or more documents by inserting a program (e.g., an OTS metering program) into the document. When the program is executed by the computing device in connection with rendering a web page, the program is configured to determine which part of the web page is displayed on the computing device (521). In some implementations, the network router, before modifying a document, determines (522) whether the document satisfies a predefined condition. For example, the network router may check the headers of data packets associated with the document and determine whether the data packets are provided by an ad server. If so, the network router goes ahead modifying the document by inserting an OTS metering program into the existing data packets or newly-generated data packets. If not, the network router skips (524) modifying the document because the document may not correspond to a predefined portion of a web page that satisfies any predefined OTS trigger conditions.

Finally, the network router sends (530) the one or more documents including the modified document to the client computing device. Up receipt of the one or more documents, the computing device may convert them (including the modified document) into a web page to be rendered on a display of the computing device. As noted above, when a user browses the web page, the inserted OTS metering program will be invoked to measure the user activities on the web page (or at least a portion of the web page that corresponds to the modified document). The OTS metering program may determine which portion of the web page is currently viewed by the user, how long the user has viewed that portion of the web page, and whether there is any interaction between the user and the portion of the web page such as mouse hovering or mouse click, etc. In some implementations, the OTS metering program first stores the OTS metering data on the client computing device and then submits the data to a remote OTS server. In some other implementations, the OTS metering program may transmit the OTS metering data on the fly while measuring the user's web browsing activities.

FIG. 5B is a flow chart illustrating how a network router works in concert with a proxy server for inspecting/modifying web contents for measuring user activities associated with the web contents before providing the modified web contents to a client in accordance with some implementations. The network router receives (540) one or more documents from one or more web servers. In some implementations, the one or more documents are responsive to a user request from the client computing device and comprise information for rendering a web page or a portion thereof on a display of a computing device. Next, the network router identifies (550) at least one of the one or more documents that satisfies a predefined condition.

The network router then forwards (560) the identified document to a remote server (e.g., a proxy server 50) that is communicatively coupled to the computing device. In some implementations, the remote server is responsible for modifying the document by inserting a program (e.g., an OTS metering program) into the document. When the program is executed by the computing device in connection with rendering a web page, the program is configured to determine which part of the web page is displayed on the computing device (565). As describe above in connection with FIG. 2B, the remote server may have a cached copy of the document such that the network router only needs to provide the identity of the document rather than the document itself. After inserting the predefined program into the document (e.g., generating one or more data packets for carrying the OTS metering program), the remote server returns the modified document (e.g., in the form of a set of data packets) to the network router.

Upon receipt of the modified document from the remote server (570), the network router then sends (580) the one or more documents including the modified document to the client computing device. The computing device then converts them (including the modified document) into a web page to be rendered on a display of the computing device. When a user browses the web page, the inserted OTS metering program will be invoked to measure the user activities on the web page (or at least a portion of the web page that corresponds to the modified document). The OTS metering program may determine which portion of the web page is currently viewed by the user, how long the user has viewed that portion of the web page, and whether there is any interaction between the user and the portion of the web page such as mouse hovering or mouse click, etc. In some implementations, the OTS metering program first stores the OTS metering data on the client computing device and then submits the data to a remote OTS server. In some other implementations, the OTS metering program may transmit the OTS metering data on the fly while measuring the user's web browsing activities.

Reference has been made in detail to implementations, examples of which are illustrated in the accompanying drawings. While particular implementations are described, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean ^{“}upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for determining a user's web browsing activities on a computing device, the method comprising:
at a network device having memory and one or more processors, wherein the network device is communicatively coupled to the computing device:
receiving one or more documents from one or more web servers, wherein the one or more documents are responsive to a user request from the computing device and comprise information for rendering a web page on a display of the computing device;
modifying at least one of the one or more documents by inserting a program into the document, wherein, when the program is executed by the computing device in connection with rendering a web page, the program is configured to determine which part of the web page is displayed on the computing device; and
sending the one or more documents including the modified document to the computing device.

2. The method of claim 1, further comprising:
before modifying a document, determining whether the document satisfies a predefined condition; and
skipping modifying the document if the document does not satisfy the predefined condition.

3. The method of claim 2, wherein the predefined condition includes the document includes one of a plurality of predefined types of content and the document is provided by one of a plurality of predefined web servers.

4. The method of claim 1, wherein the user is a panelist that has agreed to allow his or her browsing activities to be logged.

5. The method of claim 1, wherein the predefined program is a code segment written in Javascript.

6. The method of claim 1, wherein the network device is a network router.

7. The method of claim 1, wherein the one or more documents arriving at the network device are stored in a plurality of data packets and the modification of a document further includes:
identifying a first set of data packets associated with the document;
generating a second set of data packets to include the predefined program; and
updating at least one of the first set of data packets to associate the first set of data packets with the second set of data packets.

8. The method of claim 1, wherein the inserted program is configured to measure an amount of time that the user spends on a portion of the web page that corresponds to the modified document and determine whether there is any interaction between the user and the portion of the web page.

9. The method of claim 8, wherein the inserted program is configured to generate an opportunity to see (OTS) record for the user, the OTS record including data associated with the user's interaction with the portion of the web page, and submit the OTS record to a remote server for managing the user's web browsing activities.

10. A method for determining a user's web browsing activities on a computing device, the method comprising:
at a network device having memory and one or more processors, wherein the network device is communicatively coupled to the computing device:
receiving one or more documents from one or more web servers, wherein the one or more documents are responsive to a user request from the computing device and comprise information for rendering a web page on a display of the computing device;
identifying at least one of the one or more documents that satisfy a predefined condition;
forwarding the identified document to a remote server that is communicatively coupled to the computing device, wherein the remote server is configured to modify the document by inserting a program into the document and, when the program is executed by the computing device in connection with rendering a web page, the program is configured to determine which part of the web page is displayed on the computing device;
receiving the modified document from the remote server; and
sending the one or more documents including the modified document to the computing device.

11. The method of claim 10, wherein the predefined condition includes the document includes one of a plurality of predefined types of content and the document is provided by one of a plurality of predefined web servers.

12. The method of claim 10, wherein the user is a panelist that has agreed to allow his or her browsing activities to be logged.

13. The method of claim 10, wherein the predefined program is a code segment written in Javascript.

14. The method of claim 10, wherein the network device is a network router.

15. The method of claim 10, wherein the one or more documents arriving at the network device are stored in a plurality of data packets and the identification of a document further includes:
at the network device:
identifying a first set of data packets associated with the document;
examining headers of the first set of data packets to determine whether the document satisfies the predefined condition; and
if the document satisfies the predefined condition, sending a request to the remote server, the request including at least one of the first set of data packets;
at the remote server:
in response to the request from the network device, generating a second set of data packets to include the predefined program;
updating at least one of the first set of data packets to associate the first set of data packets with the second set of data packets; and
returning the updated data packet and the second set of data packets to the network device.

16. The method of claim 10, wherein the inserted program is configured to measure an amount of time that the user spends on a portion of the web page that corresponds to the modified document and determine whether there is any interaction between the user and the portion of the web page.

17. The method of claim 16, wherein the inserted program is configured to generate an opportunity to see (OTS) record for the user, the OTS record including data associated with the user's interaction with the portion of the web page, and submit the OTS record to a remote server for managing the user's web browsing activities.

18. A computer system for determining a user's web browsing activities on a computing device, comprising:
one or more processors; and
memory for storing one or more programs, wherein the one or more programs, when executed by the one or more processors, cause the computer system to:
receive one or more documents from one or more web servers, wherein the one or more documents are responsive to a user request from the computing device and comprise information for rendering a web page on a display of the computing device;
modify at least one of the one or more documents by inserting a program into the document, wherein, when the program is executed by the computing device in connection with rendering a web page, the program is configured to determine which part of the web page is displayed on the computing device; and
send the one or more documents including the modified document to the computing device.

19. A non-transitory computer readable storage medium storing one or more programs for determining a user's web browsing activities on a computing device, wherein the one or more programs, when executed by a computer system, causes the computer system to:
receive one or more documents from one or more web servers, wherein the one or more documents are responsive to a user request from the computing device and comprise information for rendering a web page on a display of the computing device;
modify at least one of the one or more documents by inserting a program into the document, wherein, when the program is executed by the computing device in connection with rendering a web page, the program is configured to determine which part of the web page is displayed on the computing device; and
send the one or more documents including the modified document to the computing device.
